(19) United States
(12) Patent Application Publication
(10) Pub. No.: US 2025/0244186 A1
(43) Pub. Date: Jul. 31, 2025

(54) TORQUE SENSING BOTTOM BRACKET

(71) Applicant: MOTEK AUTOMATION CO., LTD., NEW TAIPEI CITY (TW)

(72) Inventors: FU-CHANG HUANG, NEW TAIPEI CITY (TW); YI-RU LU, NEW TAIPEI CITY (TW); CHUN-SHENG LEE, NEW TAIPEI CITY (TW)

(21) Appl. No.: 18/670,679

(22) Filed: May 21, 2024

(30) Foreign Application Priority Data
Jan. 29, 2024 (TW) 113201009

(51) Int. Cl. G01L 3/10

(52) U.S. Cl. CPC G01L 3/102; G01L 3/105

(57) ABSTRACT

A torque sensing bottom bracket includes a bottom bracket sensor assembly that detects torque applied thereto and generates an analog torque signal, and a signal processor that receives the analog torque signal and generates a digital torque signal. The signal processor is configured to receive the digital torque signal, to perform a format conversion on the digital torque signal, and to outputs a converted digital torque signal in a specific signal format. The signal processor is then configured to output the converted digital torque signal to an external back-end device.

### CROSS-REFERENCE TO RELATED APPLICATION

This application claims priority to Taiwanese Utility Model Patent Application No. 113201009, filed on Jan. 29, 2024, and incorporated by reference herein in its entirety.

### FIELD

The disclosure relates to a sensing bottom bracket, and more particularly to a torque sensing bottom bracket.

### BACKGROUND

Electronically power assisted cycle (EPAC), or pedal electric cycle (Pedelec) has become a popular and common type of vehicle since electronic control technologies associated with the EPAC have progressed enough to allow more people to travel using the EPAC.

In use, the EPAC may be equipped with a torque sensor and an electronic control system. The torque sensor is connected to a pair of cranks that are attached with a pair of pedals, respectively, and is configured to detect torque applied by a user stepping on the pedals (referred to as a detected torque hereinafter). The electronic control system is connected to the torque sensor to obtain the detected torque therefrom, and is configured to output an auxiliary torque based on the detected torque to actuate the wheels of the EPAC. It is noted that typically, the torque sensor is configured to output the detected torque in one specific signal format. For a back-end equipment that is set to receive the detected torque (such as the electronic control system) and that does not support the signal format of the torque sensor, the detected torque may not be utilized by the backside equipment.

### SUMMARY

Therefore, one object of the disclosure is to provide a torque sensing bottom bracket that can alleviate at least one of the drawbacks of the prior art.

According to one embodiment of the disclosure, the torque sensing bottom bracket that is adapted to be connected to an external back-end device, and includes:
a bottom bracket sensor assembly that is configured to detect torque applied thereto, and to generate an analog torque signal; and
a signal processor that is connected to the bottom bracket sensor assembly, and that includes a conversion module and a signal outputting module connected to the conversion module.

The conversion module is configured to receive the analog torque signal from the bottom bracket sensor assembly, and to convert the analog torque signal into a digital torque signal. The signal outputting module is configured to receive the digital torque signal and includes a protocol conversion unit, an output control unit connected to the protocol conversion unit and an output port connected to the output control unit, the output control unit controlling the protocol conversion unit to perform a format conversion on the digital torque signal, and to output a converted digital torque signal in a specific signal format.

The output port is connected to the protocol conversion unit to receive the converted digital torque signal therefrom, and is to be connected to the external back-end device to transmit the converted digital torque signal thereto.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a torque sensing bottom bracket according to one embodiment of the disclosure.

FIG. 2 is an exploded perspective view illustrating the components of the torque sensing bottom bracket according to one embodiment of the disclosure.

FIG. 3 is a sectional view taken along the line I-I of FIG. 1, illustrating the components of the torque sensing bottom bracket according to one embodiment of the disclosure.

FIG. 4 is a block diagram illustrating the components of a torque sensor module, a cadence sensor unit, and a signal processor of the torque sensing bottom bracket according to one embodiment of the disclosure.

FIG. 5 is a block diagram similar to that of FIG. 4 and illustrating a protocol conversion unit supporting a controller area network (CAN) bus signal format.

FIG. 6 is a block diagram similar to that of FIG. 4 and illustrating the protocol conversion unit supporting a Modbus signal format.

FIG. 7 is a block diagram similar to that of FIG. 4 and illustrating the protocol conversion unit supporting a power line communication (PLC) signal format.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

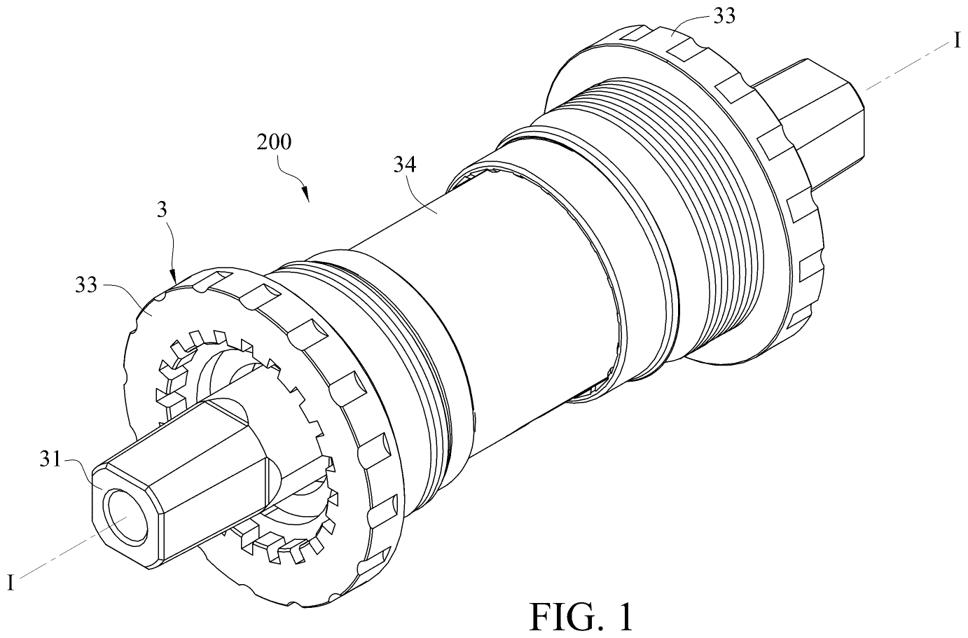

FIG. 1 is a schematic view illustrating a torque sensing bottom bracket 200 according to one embodiment of the disclosure.

In use, the torque sensing bottom bracket 200 may be installed on a vehicle (not shown), such as an electronically power assisted cycle (EPAC). The EPAC typically includes a pair of cranks and a pair of pedals that are attached to the pair of cranks, respectively. The torque sensing bottom bracket 200 may be installed to interconnect the pair of cranks.

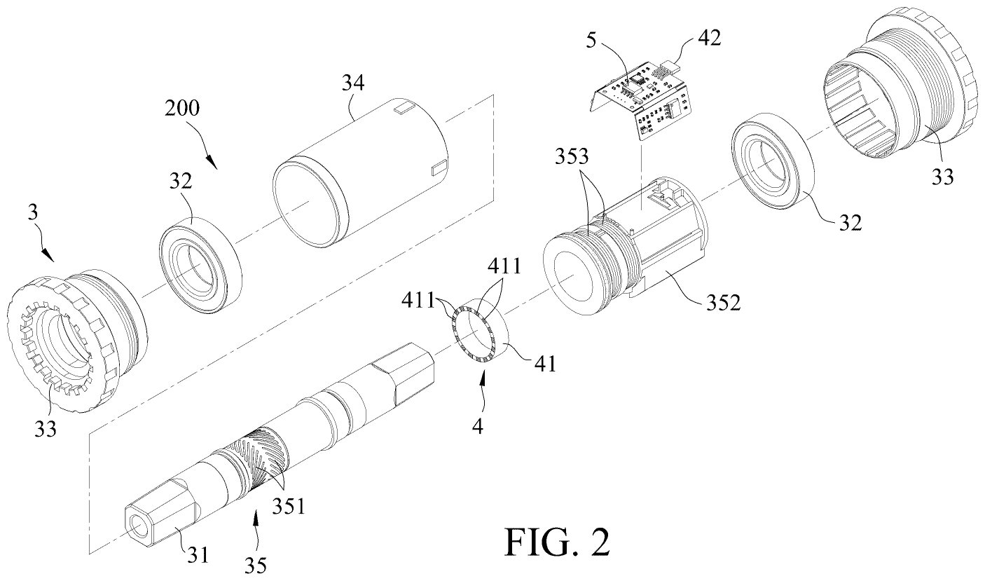

FIG. 2 is an exploded view illustrating the components of the torque sensing bottom bracket 200 according to one embodiment of the disclosure. The torque sensing bottom bracket 200 includes a bottom bracket sensor assembly 3, a cadence sensor unit 4, and a signal processor 5.

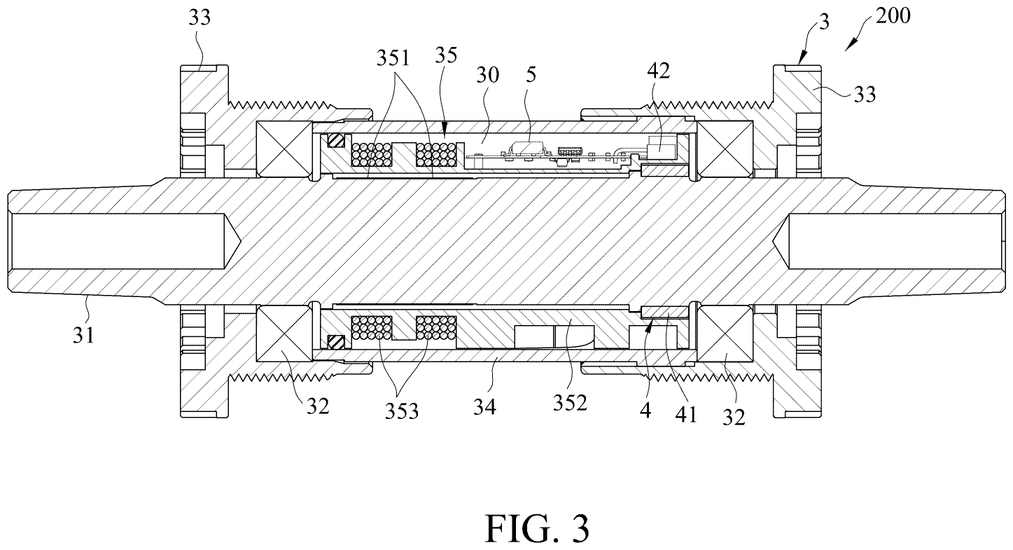

FIG. 3 is a sectional view taken along the line I-I of FIG. 1, illustrating the components of the torque sensing bottom bracket 200 according to one embodiment of the disclosure.

The bottom bracket sensor assembly 3 includes a spindle 31, two bearings 32 that are sleeved on the spindle 31 and that are spaced apart from each other along an axial direction of the spindle 31 (as indicated by the line I-I on FIG. 1), two installation cups 33 that are sleeved on the two bearings 32, respectively, such that the spindle 31 is rotatable with respect to the installation cups 33, an outer sleeve 34 that is mounted between the installation cups 33, and that surrounds and is radially spaced apart from the spindle 31, and a torque sensor module 35 that is disposed between the spindle 31 and the outer sleeve 34.

The outer sleeve 34 and the torque sensor module 35 define an installation space 30 therebetween.

The installation cups 33 are shaped such that they are able to engage a certain component of the EPAC, such as a bottom bracket shell, in order to install the torque sensing bottom bracket 200 on the EPAC. In other embodiments, the installation cups 33 may have shapes that are different from those shown in the drawings.

The torque sensor module 35 includes two magnetic alloy rings 351 that are sleeved on and fixed onto the spindle 31 and that are spaced apart from each other along the axial direction, an inner sleeve 352 that is coaxially mounted on the outer sleeve 34 so as to be sleeved by the outer sleeve 34 and that surrounds the spindle 31, two coil units 353 that are sleeved on the inner sleeve 352 and that are disposed radially around the magnetic alloy rings 351, respectively, and a torque sensor 354 that is disposed in the installation space 30 and that is connected to the coil units 353. In the embodiment of FIG. 2, the inner sleeve 352 and the outer sleeve 34 define the installation space 30 therebetween.

In use, when a user of the EPAC pushes the pedals, the cranks connected to the pedals are actuated to apply forces to two ends of the spindle 31 (torque thus applied to the spindle 31) which cause the spindle 31 to deform, and the magnetic alloy rings 351 sleeved on the spindle 31 are caused to deform as well. The torque sensor 354 may include a voltage sensor that detects changes in voltage across each of the coil units caused by the magnetostrictive effect between each of the magnetic alloy rings 351 and the respective one of the coil units 353, and generate an analog torque signal. That is to say, the bottom bracket sensor assembly 3 is configured to detect torque applied thereto, and correspondingly generate the analog torque signal. It is noted that the operations of using torque sensor module 35 to detect the torque and generating the analog torque signal are well known in the related art, details thereof are omitted herein for the sake of brevity.

The cadence sensor unit 4 includes a magnetic ring 41 that is sleeved on and fixed onto the spindle 31, and a cadence sensor 42 that is disposed on the inner sleeve 352 to connect to the signal processor 5. The magnetic ring 41 is formed with a plurality of magnetic members 411 that are disposed to radially surround the spindle 31 and that are spaced apart from one another. The cadence sensor 42 may include a sensing circuit that functions as a Hall effect sensor. In use, as the user pushes the pedals, the magnetic ring 41, along with the magnetic members 411, are driven to rotate with the spindle 31. Such a rotational movement causes a magnetic field near the cadence sensor 42 to change, and the Hall effect sensor included in the cadence sensor 42 is configured to detect the change of magnetic field that is caused by the rotational movement of the magnetic members 411 and generate a digital cadence signal based on the change of magnetic field. It is noted that the operations of the cadence sensor unit 4 are well known in the related art, details thereof are omitted herein for the sake of brevity.

As such, the torque sensing bottom bracket 200 is configured to detect torque related to forces applied to the pedals, and a cadence of the user pushing the pedals.

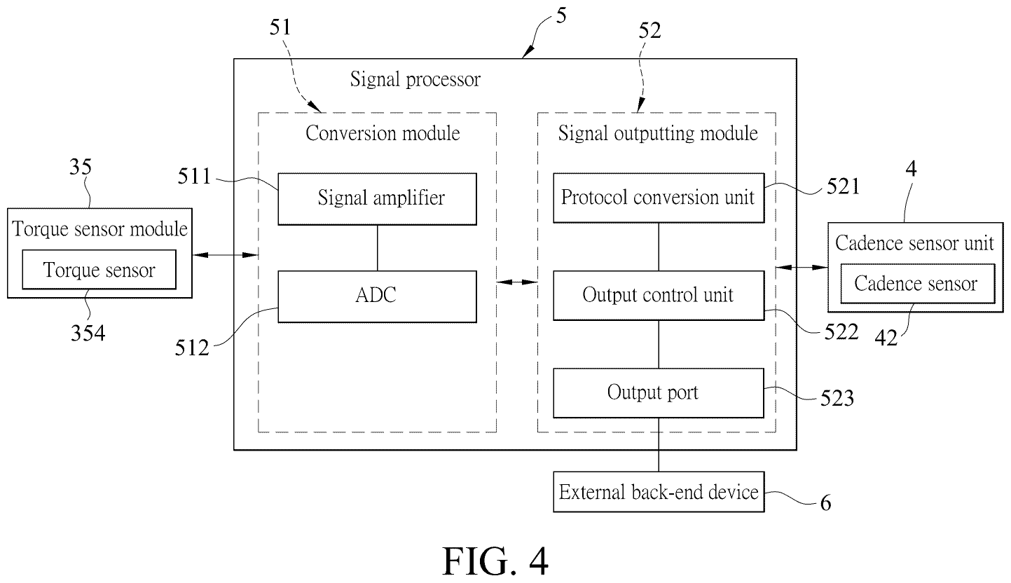

FIG. 4 is a block diagram illustrating the components of the torque sensor module 35, the cadence sensor unit 4, and the signal processor 5 according to one embodiment of the disclosure. In the embodiment of FIG. 3, the signal processor 5 is mounted on the inner sleeve 352, is disposed in the installation space 30, is connected to the torque sensor module 35 of the bottom bracket sensor assembly 3 and the cadence sensor unit 4, and may be embodied using an electronic circuit board that contains a microprocessor and/or electronic circuits thereon that are configured to perform the following operations. It is noted that in some embodiments, the torque sensor 354 may also be disposed on the signal processor 5.

Specifically, the signal processor 5 includes a conversion module 51 and a signal outputting module 52. The conversion module 51 is connected to the torque sensor 354, and includes a signal amplifier 511 and an analog-to-digital converter (ADC) 512. The signal amplifier 511 is connected to the torque sensor 354 to receive the analog torque signal therefrom, amplifies the analog torque signal, and outputs an amplified analog torque signal. The ADC 512 receives the amplified analog torque signal, performs an analog-to-digital conversion on the amplified analog torque signal, and generates a digital torque signal. It is noted the operations of the signal amplifier 511 and the ADC 512 are well known in the related art, details thereof are omitted herein for the sake of brevity.

The signal outputting module 52 is connected to the cadence sensor unit 4, and includes a protocol conversion unit 521, an output control unit 522, and an output port 523.

The protocol conversion unit 521 is connected to the ADC 512 and the cadence sensor unit 4 to receive the digital torque signal and the digital cadence signal therefrom, respectively. In response to receipt of the digital torque signal, the protocol conversion unit 521 performs a format conversion on the digital torque signal, and outputs a converted digital torque signal in a specific signal format. In response to receipt of the digital cadence signal, the protocol conversion unit 521 performs the format conversion on the digital cadence signal, and outputs a converted digital cadence signal in a specific signal format.

The output control unit 522 may be embodied using a three way switch, and is configured to control the protocol conversion unit 521 to generate the converted digital torque signal and the converted digital cadence signal in one of three predetermined signal formats. In the embodiment of FIG. 4, the protocol conversion unit 521 may include suitable electronic circuits that are capable of converting each of the digital torque signal and the digital cadence signal into a controller area network (CAN) bus signal format that supports the CAN bus standard, a Modbus signal format that supports the Modbus protocol, and a power line communication (PLC) signal format that is capable of being transmitted as a modulated carrier signal. In other embodiments, the output control unit 522 may be embodied using an electronic switch that may be operated using a remote controller.

The output port 523 is connected to the protocol conversion unit 521, and is configured to be connected to an external back-end device 6, so as to transmit the converted digital torque signal and/or the converted digital cadence signal to the external back-end device 6. In embodiments, the external back-end device 6 may be an electronic control system of the EPAC that is configured to control a motor to output an auxiliary torque based on the converted digital torque signal to actuate the wheels of the EPAC, a recorder for storing the converted digital cadence signal for further processing, etc.

In use, after the electronic control system of the EPAC is powered on, the bottom bracket sensor assembly 3 generates the analog torque signal, and the cadence sensor unit 4 generates the digital cadence signal. After the conversion module 51 converts the analog torque signal into the digital torque signal, the signal outputting module 52 receives the digital torque signal, and the output control unit 522 is operable by the user to operate in one of a first operation mode, a second operation mode, and a third operation mode. In the embodiment of FIG. 4, in the first operation mode, the output control unit 522 controls the protocol conversion unit 521 to convert the digital torque signal into the converted digital torque signal in the CAN bus signal format, and to convert the digital cadence signal into the converted digital cadence signal in the CAN bus signal format. In the second operation mode, the output control unit 522 controls the protocol conversion unit 52 to convert the digital torque signal into the converted digital torque signal in the Modbus signal format, and to convert the digital cadence signal into the converted digital cadence signal in the Modbus signal format. In the third operation mode, the output control unit 522 controls the protocol conversion unit 52 to convert the digital torque signal into the converted digital torque signal in the PLC signal format, and to convert the digital cadence signal into the converted digital cadence signal in the PLC signal format. In other embodiments, the protocol conversion unit 521 may support signal conversion into additional signal formats, and the output control unit 522 may be embodied using another switch that enables selection among all the supported signal formats.

Afterward, the converted digital torque signal and the converted digital cadence signal may be transmitted via the output port 523 to the external back-end device 6.

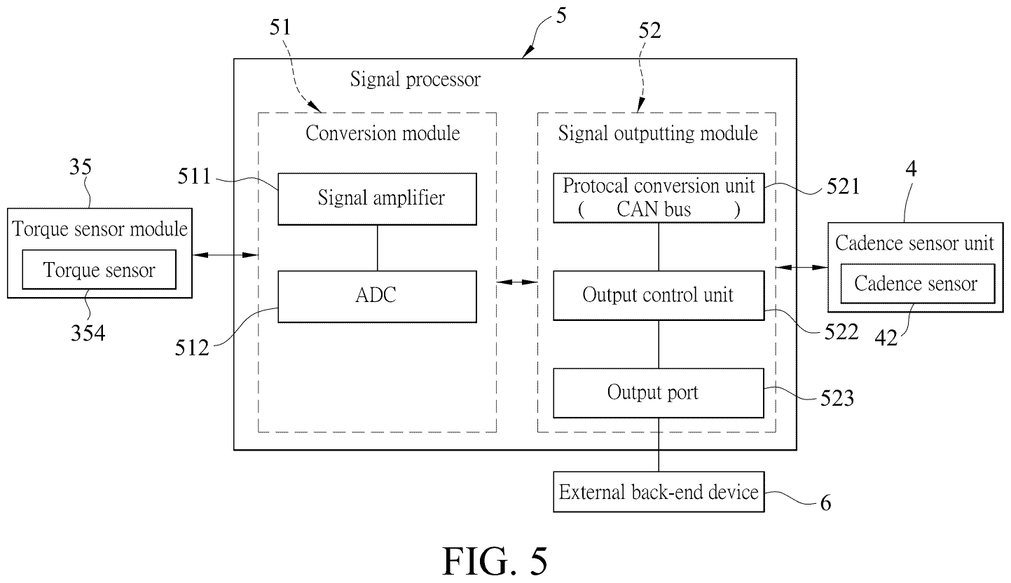

FIG. 5 is a block diagram illustrating the components of a torque sensor module, a cadence sensor unit, and a signal processor of the torque sensing bottom bracket according to one embodiment of the disclosure. In the embodiment of FIG. 5, the output control unit 522 is preset to operate in the first operation mode, and the output control unit 522 controls the protocol conversion unit 521 to convert the digital torque signal into the converted digital torque signal in the CAN bus signal format, and to convert the digital cadence signal into the converted digital cadence signal in the CAN bus signal format.

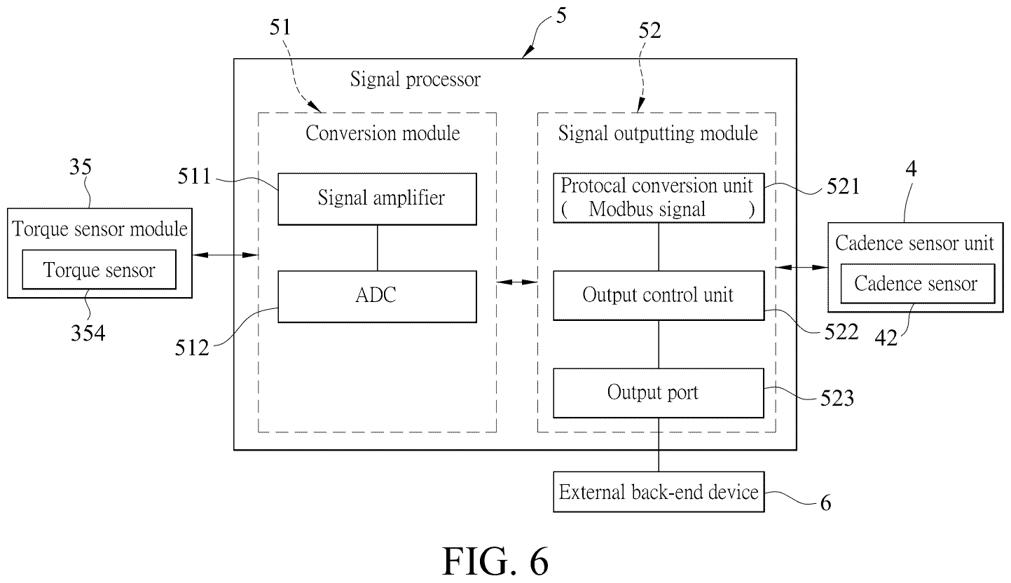

FIG. 6 is a block diagram illustrating the components of a torque sensor module, a cadence sensor unit, and a signal processor of the torque sensing bottom bracket according to one embodiment of the disclosure. In the embodiment of FIG. 6, the output control unit 522 is preset to operate in the second operation mode, and the output control unit 522 controls the protocol conversion unit 521 to convert the digital torque signal into the converted digital torque signal in the Modbus signal format, and to convert the digital cadence signal into the converted digital cadence signal in the Modbus signal format.

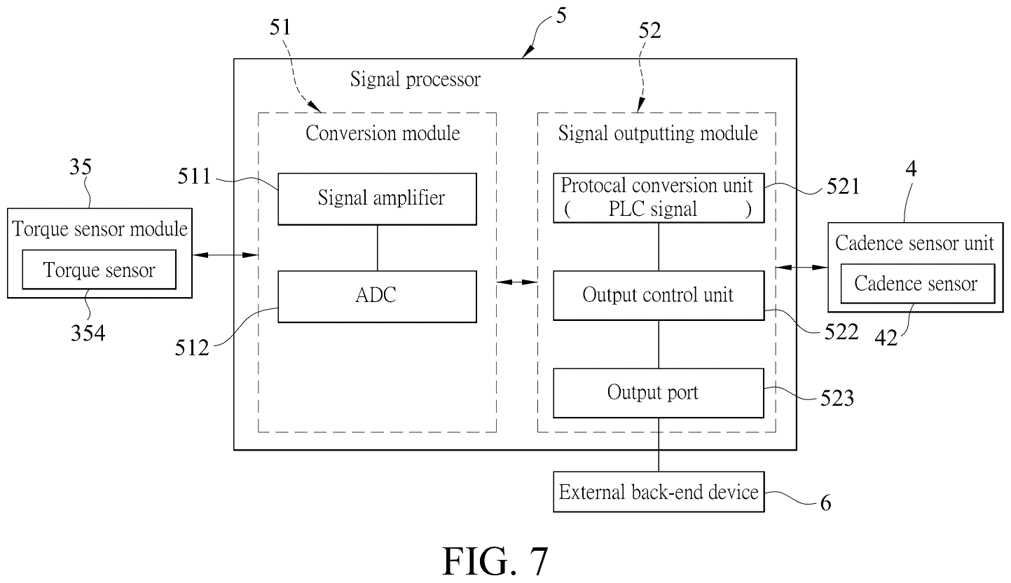

FIG. 7 is a block diagram illustrating the components of a torque sensor module, a cadence sensor unit, and a signal processor of the torque sensing bottom bracket according to one embodiment of the disclosure. In the embodiment of FIG. 6, the output control unit 522 is preset to operate in the third operation mode, and the output control unit 522 controls the protocol conversion unit 521 to convert the digital torque signal into the converted digital torque signal in the PLC signal format, and to convert the digital cadence signal into the converted digital cadence signal in the PLC signal format.

To sum up, embodiments of the disclosure provide a torque sensing bottom bracket 200 including a signal processor 5 that is configured to convert the analog torque signal, which is generated by the bottom bracket sensor assembly 3, into a digital analog torque signal, and to generate the converted digital torque signal and the converted digital cadence signal in one of the three predetermined signal formats (e.g., the CAN bus signal format, the Modbus signal format, and the PLC signal format) based on a selection of the user. As such, the torque sensing bottom bracket 200 may be adapted to be connected to various external back-end devices 6, which may individually support different signal formats, exclusively. This configuration enables the torque sensing bottom bracket 200 to be more widely used without the need of additional adaptors or converters for converting the signals into different formats.

According to some embodiments of the disclosure, the torque sensing bottom bracket 200 may include only the bottom bracket sensor assembly 3 and the signal processor 5. That is to say, the cadence sensor unit 4 may be omitted, and the signal processor 5 in turn may only receive and convert the analog torque signal into the converted digital torque signal, and to transmit the converted digital torque signal to the external back-end device 6.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A torque sensing bottom bracket that is adapted to be connected to an external back-end device, and comprising:
a bottom bracket sensor assembly that is configured to detect torque applied thereto, and to generate an analog torque signal; and
a signal processor that is connected to the bottom bracket sensor assembly, and that includes a conversion module and a signal outputting module connected to the conversion module,
wherein the conversion module is configured to receive the analog torque signal from the bottom bracket sensor assembly, and to convert the analog torque signal into a digital torque signal;
the signal outputting module is configured to receive the digital torque signal and includes a protocol conversion unit, an output control unit connected to the protocol conversion unit and an output port connected to the output control unit, the output control unit controlling the protocol conversion unit to perform a format conversion on the digital torque signal, and to output a converted digital torque signal in a specific signal format; and
the output port is connected to the protocol conversion unit to receive the converted digital torque signal therefrom, and is to be connected to the external back-end device to transmit the converted digital torque signal thereto.

2. The torque sensing bottom bracket as claimed in claim 1, wherein the output control unit controls the protocol conversion unit to convert the digital torque signal into the converted digital torque signal in a controller area network (CAN) bus signal format that supports the CAN bus standard.

3. The torque sensing bottom bracket as claimed in claim 1, wherein the output control unit controls the protocol conversion unit to convert the digital torque signal into the converted digital torque signal in a Modbus signal format that supports the Modbus standard.

4. The torque sensing bottom bracket as claimed in claim 1, wherein the output control unit controls the protocol conversion unit to convert the digital torque signal into the converted digital torque signal in a power line communication (PLC) signal format that is capable of being transmitted as a modulated carrier signal.

5. The torque sensing bottom bracket as claimed in claim 1, wherein the bottom bracket sensor assembly includes:
a spindle;
two bearings that are sleeved on the spindle and that are spaced apart from each other along an axial direction of the spindle;
two installation cups that are sleeved on the two bearings, respectively such that the spindle is rotatable with respect to the installation cups;
an outer sleeve that is mounted between the installation cups, and that surrounds and is radially spaced apart from the spindle; and
a torque sensor module that is disposed between the spindle and the outer sleeve;
wherein the outer sleeve and the torque sensor module define an installation space therebetween, and the signal processor is disposed in the installation space and is connected to the bottom bracket sensor assembly.

6. The torque sensing bottom bracket as claimed in claim 5, wherein:
the conversion module of the signal processor includes a signal amplifier and an analog-to-digital converter (ADC);
the signal amplifier is connected the bottom bracket sensor assembly to receive the analog torque signal therefrom, and outputs an amplified analog torque signal; and
the ADC receives the amplified analog torque signal, performs an analog-to-digital conversion on the amplified analog torque signal, and generates a digital torque signal.

7. The torque sensing bottom bracket as claimed in claim 5, further comprising a cadence sensor unit that includes a magnetic ring that is sleeved on and fixed onto the spindle, and a cadence sensor that is disposed on the torque sensor module;
wherein the magnetic ring is formed with a plurality of magnetic members that are disposed to radially surround the spindle and that are spaced apart from one another; and
the cadence sensor is configured to detect a change of magnetic field caused by the magnetic members, and to generate a digital cadence signal based on the change of magnetic field.

8. The torque sensing bottom bracket as claimed in claim 7, wherein:
the signal processor is further connected to the cadence sensor unit to receive the digital cadence signal therefrom;
in receipt of the digital cadence signal, the output control unit controls the protocol conversion unit to perform a format conversion on the digital cadence signal, and to output a converted digital cadence signal in a specific signal format.

9. The torque sensing bottom bracket as claimed in claim 8, wherein the output control unit controls the protocol conversion unit to convert the digital cadence signal into the converted digital cadence signal in a CAN bus signal format that supports the CAN bus standard.

10. The torque sensing bottom bracket as claimed in claim 8, wherein the output control unit controls the protocol conversion unit to convert the digital cadence signal into the converted digital cadence signal in a Modbus signal format that supports the Modbus standard.

11. The torque sensing bottom bracket as claimed in claim 8, wherein the output control unit controls the protocol conversion unit to convert the digital cadence signal into the converted digital cadence signal in a PLC signal format that is capable of being transmitted as a modulated carrier signal.
